(19) United States
(12) Patent Application Publication
(10) Pub. No.: US 2021/0237000 A1
(43) Pub. Date: Aug. 5, 2021

(54) Perfluoropolymer hollow fiber composite membrane preparation method

(71) Applicant: Shanghai University of Engineering Science, Shanghai (CN)

(72) Inventors: Changfa Xiao, Shanghai (CN); Kaikai Chen, Shanghai (CN); Yan Huang, Shanghai (CN); Chun Wang, Shanghai (CN)

(73) Assignee: Shanghai University of Engineering Science

(21) Appl. No.: 17/238,229

(22) Filed: Apr. 23, 2021

(30) Foreign Application Priority Data
Oct. 9, 2020 (CN) 202011075066.9

(51) Int. Cl. B01D 69/08; B01D 69/12; B01D 67/00; B01D 71/36; B01D 71/52; B01D 69/02

(52) U.S. Cl. CPC B01D 69/087; B01D 69/12; B01D 67/0095; B01D 67/0097; B01D 67/0013; B01D 67/0011; B01D 2325/30; B01D 71/36; B01D 71/52; B01D 69/02; B01D 2325/22; B01D 2325/24; B01D 67/0016

(57) ABSTRACT

A perfluoropolymer hollow fiber composite membrane preparation method includes the steps of (A) preparing a supporting layer of the perfluoropolymer hollow fiber composite membrane, (B) preparing a membrane casting solution, which includes obtaining a mixed solution by mixing a perfluoropolymer water dispersion emulsion, a spinning carrier and solvent, and defoaming the mixed solution at vacuum and a constant temperature, (C) preparing a nascent hollow fiber composite membrane, which includes compositing by uniformly coating the membrane casting solution on an outer surface of the supporting layer through an annular spinneret using chemical fiber concentric circle composite spinning technology, putting the supporting layer after compositing into a coagulant, solidifying and forming, and (D) drying after putting the nascent hollow fiber composite membrane to a hot air box, cleaning, sintering, and performing heat preservation. The prepared membrane has a thin wall, thermal and chemical resistance and good mechanical performance.

### CROSS REFERENCE OF RELATED APPLICATION

The present invention claims priority under 35 U.S.C. 119(a-d) to CN 202011075066.9, filed Oct. 9, 2020.

### BACKGROUND OF THE PRESENT INVENTION

### Field of Invention

The present invention relates to the field of hollow fiber membrane technology, and more particularly to a perfluoropolymer hollow fiber composite membrane preparation method.

### Description of Related Arts

The emergence of membrane separation technology based on the osmotic pressure principle for desalination. Some advantages of the membrane separation process over mature and commercially available technologies such as low energy consumption, high efficiency, strong applicability, convenient operation, friendly environment, easy large-scale production, and integration with other technologies. At present, it is regarded as the core technology in the field of water treatment. Especially, and its research and application in the field of used-oil regeneration, oil purification, and sewage purification from heavy-metal ions are also getting more attention.

The hollow fiber membrane technologies with high separation accuracy and efficiency, low device investment and operating costs and easy engineering processes, have historically received widespread attention. Commonly used polymer membrane materials are polyvinylidene fluoride, polysulfone, and polyethersulfone, which have good oxidation resistance and easy processing performance, but poor thermal and chemical resistance. Polytetrafluoroethylene (PTFE) is a perfluorinated linear polymer with high C—F bond energy and short bond length, wherein the F atoms are densely arranged around the main chain of C—C macromolecules, which makes PTFE exhibit excellent chemical and thermal stability, non-sticky and lubricity, so that PTFE is widely used as a filtering material for liquid, gas and particulate in harsh environment. Moreover, there is no existing chemical reagent to dissolve PTFE due to its extremely strong chemical stability. It is difficult to prepare the hollow fiber ultrafiltration membrane by melt or solution spinning like polyvinylidene fluoride, and polyolefin because of the PTFE with high melting point (327° C.) and viscous flow state (poor processing performance). The application of PTFE is limited owing to the only extrusion-stretching method and uncontrollable pore size. Moreover, the characteristics of “insoluble and infusible” also make the reuse of various waste PTFE materials a difficult problem. Currently, only passive ways such as incineration, landfill or storage can be used to treat the PTFE materials. In order to overcome the deficiencies of poor processing performance and difficult recycling of PTFE, the development of melt-processable thermoplastic perfluoropolymers has received widespread attention. Among them, polyperfluoroethylene propylene (FEP) and tetrafluoroethylene-perfluoropropyl vinyl ether copolymer (PFA) are the two most representative thermoplastic perfluoropolymers.

In view of the environmental protection requirements in used-oil regeneration, oil purification, and heavy and complex sewage fields (high temperature, acid-base, organic wastewater), the advantages of perfluoropolymer with chemical and thermal stability, non-sticky and lubricity. It is of great significance to prepare reinforced perfluoropolymer hollow fiber membranes with thermal and chemical resistance and good mechanical performance.

At present, the reinforced hollow fiber ultra-microfiltration membrane (such as CN104815563A, CN103111194A and US2012/0276294A1) generally comprises a fiber braided tube or porous base membrane as a supporting layer, and a membrane-forming polymer such as cellulose acetate, polyvinyl chloride and polyvinylidene fluoride coated on the supporting layer. The preparation method of the membrane still uses the traditional spinning process (phase inversion method), which requires a large amount of toxic solvents and diluents. As a result, a large amount of toxic waste water is produced during the preparation method of the membrane. Green (environmental protection) membrane preparation technology aims to reduce the toxicity of waste water and reduce environmental pollution through the use of low-toxic or non-toxic solvents and diluents, thereby realizing the sustainable development of membrane technology. Up to now, there is no report on the preparation method of perfluoropolymer hollow fiber membranes using chemical fiber concentric circle composite spinning technology.

### SUMMARY OF THE PRESENT INVENTION

An object of the present invention is to provide a method for preparing a perfluoropolymer hollow fiber composite membrane through using chemical fiber concentric circle composite spinning technology, which has a thin wall, thermal and chemical resistance and good mechanical performance.

Another object of the present invention is to provide the perfluoropolymer hollow fiber composite membrane prepared by the aforementioned method.

Accordingly, the present invention adopts technical solutions as follows.

A perfluoropolymer hollow fiber composite membrane preparation method comprises the steps of:
(A) preparing a supporting layer of the perfluoropolymer hollow fiber composite membrane;
(B) preparing a membrane casting solution, which comprises obtaining a mixed solution by mixing a perfluoropolymer water dispersion emulsion, a spinning carrier and solvent at a temperature in a range of 60−90° C., and defoaming the mixed solution at a constant temperature, so that the membrane casting solution is obtained, wherein a proportion of the perfluoropolymer water dispersion emulsion in the mixed solution is in a range of 10-40 wt. %, a proportion of the spinning carrier in the mixed solution is in a range of 5-20 wt. %, and a proportion of the solvent in the mixed solution is in a range of 40-85 wt. %;
(C) preparing a nascent hollow fiber composite membrane, which comprises compositing by uniformly coating the membrane casting solution on an outer surface of the supporting layer through an annular spinneret with a temperature in a range of 60−90° C. using chemical fiber concentric circle composite spinning technology, putting the supporting layer after compositing into a coagulant, solidifying and forming, so that the nascent hollow fiber composite membrane is obtained; and
(D) drying for 10-30 min after putting the nascent hollow fiber composite membrane to a hot air box with a temperature in a range of 40−80° C., removing residual coagulant by immersing the dried nascent hollow fiber composite membrane into deionized water, putting the dried nascent hollow fiber composite membrane without the residual coagulant into a heat treatment device, heating to 200-400° C. at a heating rate in a range of 5-20° C./min, sintering, and performing heat preservation for 0.5-5 h, so that the perfluoropolymer hollow fiber composite membrane, comprising the supporting layer and a surface separation layer coated on the supporting layer, is obtained,
wherein the perfluoropolymer is at least one member selected from a group consisting of thermoplastic polyperfluoroethylene propylene (FEP) and thermoplastic tetrafluoroethylene-perfluoropropyl vinyl ether copolymer (PFA).

Preferably, a content of the perfluoropolymer in the perfluoropolymer water dispersion emulsion is in a range of 30-70 wt. %.

Preferably, fiber filaments for preparing the supporting layer are acid and alkali resistant glass fiber filaments, basalt fiber filaments, aromatic polyamide fiber (aramid 1414) filaments or polyimide fiber filaments; the step (A) comprises weaving the fiber filaments into fiber braided tube through two-dimensional weaving technology, and performing heat treatment on the fiber braided tube to eliminate an internal stress and fix a net structure thereof, thereby obtaining the supporting layer of the perfluoropolymer hollow fiber composite membrane.

Preferably, the spinning carrier is a polyvinyl alcohol aqueous solution with a concentration in a range of 4-10 wt. %, a carboxymethyl cellulose aqueous solution with a concentration in a range of 4-10 wt. %, or a mixture of cellulose with a proportion in a range of 4-10 wt. % in the mixture and an N-methylmorpholine-N-oxide aqueous solution with a proportion in a range of 90-96 wt. % in the mixture, wherein the N-methylmorpholine-N-oxide aqueous solution comprises 87 wt. % of N-methylmorpholine-N-oxide and 13 wt. % of water.

Preferably, the solvent is deionized water or N-methylmorpholine-N-oxide aqueous solution, wherein the N-methylmorpholine-N-oxide aqueous solution comprises 87 wt. % of N-methylmorpholine-N-oxide and 13 wt. % of water.

Preferably, the coagulant is an inorganic salt saturated aqueous solution which is one or two members selected from a group consisting of a sodium sulfate saturated aqueous solution, a potassium sulfate saturated aqueous solution, and an ammonium sulfate saturated aqueous solution; or the coagulant is anhydrous ethanol, anhydrous methanol or deionized water.

Preferably, the surface separation layer has a thickness in a range of 10-100 μm, and an outer diameter of the supporting layer is in a range of 500-2000 μm.

Preferably, the heat treatment device is an intermittent hot box treatment device, a continuous hot roll treatment device or a continuous hot plate treatment device.

The perfluoropolymer hollow fiber composite membrane prepared by the aforementioned method has an oil flux in a range of 200-1300 L·m⁻²·h⁻¹·bar and an organic solvent flux in a range of 300-1500 L·m⁻²·h⁻¹·bar, wherein the oil is kerosene, diesel, gasoline, benzene or halogenated alkanes; the solvent is N,N-dimethylformamide, N,N-dimethylacetamide, dimethyl sulfoxide or N-methylpyrrolidone.

The perfluoropolymer hollow fiber composite membrane prepared by the same method comprises the supporting layer and the surface separation layer as a functional layer coated on the supporting layer.

Compared with the prior art, beneficially effects of the present invention are as follows.
(1) The preparation method provided by the present invention adopts the chemical fiber concentric circle composite spinning technology to combine the thermoplastic perfluoropolymer with the supporting layer. By controlling the sintering temperature, the preparation method effectively avoids the defect that the enhanced membrane material easily causes interface peeling due to poor thermodynamic compatibility between the thermoplastic perfluoropolymer and the supporting layer, which solves the problems of poor processing performance and difficult recovery of PTFE. The preparation method is environmentally friendly and convenient for industrialization.
(2) The perfluoropolymer hollow fiber composite membrane prepared by the method provided by the present invention comprises the supporting layer and the surface separation layer coated on the supporting layer, which has advantages of thin wall, thermal and chemical resistance and good mechanical performance, solves the key technical bottlenecks in the application process of conventional membrane materials such as poor thermal and chemical resistance, and provides a scientific basis for the application of a new generation of polymer hollow fiber membrane materials and their separation technology in the chemical industry.

### BRIEF DESCRIPTION OF THE DRAWINGS

FIG. 1 is a cross-sectional schematic diagram of a perfluoropolymer hollow fiber composite membrane provided by the present invention.

FIG. 2 is aouter surface SEM images of the perfluoropolymer hollow fiber composite membrane prepared by the method according to the first embodiment of the present invention.

FIG. 3 is across-sectional SEM images of the perfluoropolymer hollow fiber composite membrane in FIG. 2.

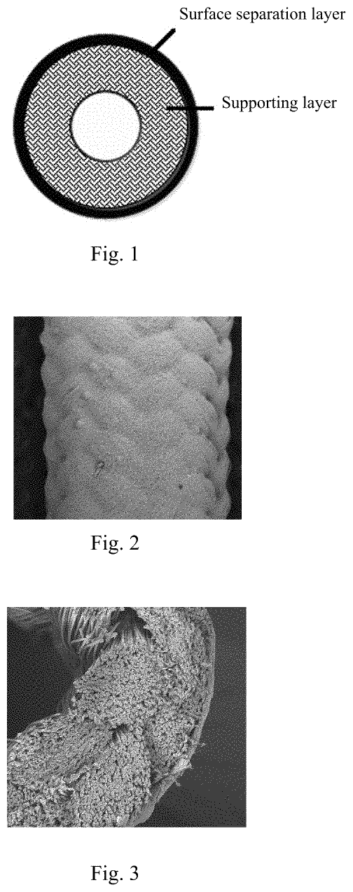

### DETAILED DESCRIPTION OF THE PREFERRED EMBODIMENT

The technical solutions of the present invention will be described in detail in combination with embodiments as follows. The specific embodiments are only used to further specify the present invention without limiting the protection scope of the claims of the present application.

In the following embodiments, a concentration of a polyvinyl alcohol aqueous solution is in a range of 4-10 wt. %.

### First Embodiment

A perfluoropolymer hollow fiber composite membrane preparation method comprises the steps of:
(A) preparing a supporting layer of the perfluoropolymer hollow fiber composite membrane, which comprises weaving polyparaphenylene terephthalamide fiber filaments into fiber braided tube with an outer diameter of 800 μm through two-dimensional weaving technology, and performing heat treatment on the fiber braided tube at 300° C. for 5 min to eliminate an internal stress and fix a net structure thereof, thereby obtaining the supporting layer of the perfluoropolymer hollow fiber composite membrane;
(B) preparing a membrane casting solution as a functional layer, which comprises obtaining a mixed solution by mixing a polyperfluoroethylene propylene water dispersion emulsion with a concentration of 40 wt. %, a polyvinyl alcohol aqueous solution and a first amount of deionized water at 80° C., and defoaming the mixed solution at a constant temperature, so that the membrane casting solution is obtained, wherein a proportion of the polyperfluoroethylene propylene water dispersion emulsion in the mixed solution is 18 wt. %, a proportion of the polyvinyl alcohol aqueous solution in the mixed solution is 7 wt. %, and a proportion of the first amount of deionized water in the mixed solution is 75 wt. %;
(C) preparing a nascent hollow fiber composite membrane, which comprises compositing by uniformly coating the membrane casting solution on an outer surface of the supporting layer through an annular spinneret with a temperature of 60° C. using chemical fiber concentric circle composite spinning technology, putting the supporting layer after compositing into a saturated sodium sulfate aqueous solution with a concentration of 49 wt. % and a temperature of 40° C. as coagulating bath, and forming, so that the nascent hollow fiber composite membrane is obtained; and
(D) drying for 10 min after putting the nascent hollow fiber composite membrane to a hot air box with a temperature of 70° C., removing residual sodium sulfate by immersing the dried nascent hollow fiber composite membrane into a second amount of deionized water, putting the dried nascent hollow fiber composite membrane without the residual sodium sulfate into a multi-roll heat treatment device, heating to 230° C. at a heating rate of 5° C./min, sintering, and performing heat preservation for 5 h, so that the perfluoropolymer hollow fiber composite membrane is obtained.

The perfluoropolymer hollow fiber composite membrane prepared by the aforementioned method has a surface separation layer with a thickness of 90 μm. After being continuously tested for 1 h under an operating pressure of 0.02 MPa, the perfluoropolymer hollow fiber composite membrane has a kerosene flux of 300 L·m⁻²·h⁻¹·bar and an N,N-dimethylacetamide flux of 550 L·m⁻²·h⁻¹·bar.

### Second Embodiment

A perfluoropolymer hollow fiber composite membrane preparation method comprises the steps of:
(A) preparing a supporting layer of the perfluoropolymer hollow fiber composite membrane, which comprises weaving glass fiber filaments into fiber braided tube with an outer diameter of 1000 μm through two-dimensional weaving technology, and performing heat treatment on the fiber braided tube at 250° C. for 5 min to eliminate an internal stress and fix a net structure thereof, thereby obtaining the supporting layer of the perfluoropolymer hollow fiber composite membrane;
(B) preparing a membrane casting solution as a functional layer, which comprises obtaining a mixed solution by mixing a polyperfluoroethylene propylene water dispersion emulsion with a concentration of 60 wt. %, a polyvinyl alcohol aqueous solution and a first amount of deionized water at 90° C., and defoaming the mixed solution at a constant temperature, so that the membrane casting solution is obtained, wherein a proportion of the polyperfluoroethylene propylene water dispersion emulsion in the mixed solution is 23 wt. %, a proportion of the polyvinyl alcohol aqueous solution in the mixed solution is 3 wt. %, and a proportion of the first amount of deionized water in the mixed solution is 74%;
(C) preparing a nascent hollow fiber composite membrane, which comprises compositing by uniformly coating the membrane casting solution on an outer surface of the supporting layer through an annular spinneret with a temperature of 70° C. using chemical fiber concentric circle composite spinning technology, putting the supporting layer after compositing into an absolute ethanol with a temperature of 25° C., solidifying and forming, so that the nascent hollow fiber composite membrane is obtained; and
(D) drying for 10 min after putting the nascent hollow fiber composite membrane to a hot air box with a temperature of 60° C., removing residual ethanol by immersing the dried nascent hollow fiber composite membrane into a second amount of deionized water, putting the dried nascent hollow fiber composite membrane without the residual ethanol into a multi-roll heat treatment device, heating to 250° C. at a heating rate of 10° C./min, sintering, and performing heat preservation for 3 h, so that the perfluoropolymer hollow fiber composite membrane is obtained.

The perfluoropolymer hollow fiber composite membrane prepared by the above method has a surface separation layer with a thickness of 70 After being continuously tested for 1 h under an operating pressure of 0.02 MPa, the perfluoropolymer hollow fiber composite membrane has a kerosene flux of 600 L·m⁻²·⁻¹·bar and an N-methylpyrrolidine flux of 900 L·m⁻²·h⁻¹·bar.

### Third Embodiment

A perfluoropolymer hollow fiber composite membrane preparation method comprises the steps of:
(A) preparing a supporting layer of the perfluoropolymer hollow fiber composite membrane, which comprises weaving polyparaphenylene terephthalamide fiber filaments into fiber braided tube with an outer diameter of 1200 μm through two-dimensional weaving technology, and performing heat treatment on the fiber braided tube at 300° C. for 5 min to eliminate an internal stress and fix a net structure thereof, thereby obtaining the supporting layer of the perfluoropolymer hollow fiber composite membrane;
(B) preparing a membrane casting solution as a functional layer, which comprises obtaining a mixed solution by mixing a polyperfluoroethylene propylene water dispersion emulsion with a concentration of 50 wt. %, a polyvinyl alcohol aqueous solution and a first amount of deionized water at 80° C., and defoaming the mixed solution at a constant temperature, so that the membrane casting solution is obtained, wherein a proportion of the polyperfluoroethylene propylene water dispersion emulsion in the mixed solution is 25 wt. %, a proportion of the polyvinyl alcohol aqueous solution in the mixed solution is 5 wt. %, and a proportion of the first amount of deionized water in the mixed solution is 70%;
(C) preparing a nascent hollow fiber composite membrane, which comprises compositing by uniformly coating the membrane casting solution on an outer surface of the supporting layer through an annular spinneret with a temperature of 70° C. using chemical fiber concentric circle composite spinning technology, putting the supporting layer after compositing into a saturated potassium sulfate aqueous solution with a concentration of 9 wt. % and a temperature of 35° C. as coagulating bath, and forming, so that the nascent hollow fiber composite membrane is obtained; and
(D) drying for 10 min after putting the nascent hollow fiber composite membrane to a hot air box with a temperature of 75° C., removing residual potassium sulfate by immersing the dried nascent hollow fiber composite membrane into a second amount of deionized water, putting the dried nascent hollow fiber composite membrane without the residual potassium sulfate into a multi-roll heat treatment device, heating to 270° C. at a heating rate of 15° C./min, sintering, and performing heat preservation for 1.5 h, so that the perfluoropolymer hollow fiber composite membrane is obtained.

The perfluoropolymer hollow fiber composite membrane prepared by the above method has a surface separation layer with a thickness of 50 After being continuously tested for 1 h under an operating pressure of 0.02 MPa, the perfluoropolymer hollow fiber composite membrane has a kerosene flux of 900 L·m⁻²·h⁻¹·bar and an N,N-dimethylformamide flux of 1100 L·m⁻²·h⁻¹·bar.

### Fourth Embodiment

A perfluoropolymer hollow fiber composite membrane preparation method comprises the steps of:
(A) preparing a supporting layer of the perfluoropolymer hollow fiber composite membrane, which comprises weaving polymetaphenylene isophthalamide fiber filaments into fiber braided tube with an outer diameter of 1300 μm through two-dimensional weaving technology, and performing heat treatment on the fiber braided tube at 200° C. for 5 min to eliminate an internal stress and fix a net structure thereof, thereby obtaining the supporting layer of the perfluoropolymer hollow fiber composite membrane;
(B) preparing a membrane casting solution as a functional layer, which comprises obtaining a mixed solution by mixing a water dispersion emulsion of tetrafluoroethylene-perfluoropropyl vinyl ether copolymer with a concentration of 60 wt. %, acarboxymethyl cellulose aqueous solution and a first amount of deionized water at 75° C., and defoaming the mixed solution at a constant temperature, so that the membrane casting solution is obtained, wherein a proportion of the water dispersion emulsion of tetrafluoroethylene-perfluoropropyl vinyl ether copolymer in the mixed solution is 22 wt. %, a proportion of the carboxymethyl cellulose aqueous solution in the mixed solution is 6 wt. %, and a proportion of the first amount of deionized water in the mixed solution is 72 wt. %;
(C) preparing a nascent hollow fiber composite membrane, which comprises compositing by uniformly coating the membrane casting solution on an outer surface of the supporting layer through an annular spinneret with a temperature of 70° C. using chemical fiber concentric circle composite spinning technology, putting the supporting layer after compositing into a saturated ammonium sulfate aqueous solution with a concentration of 44 wt. % and a temperature of 30° C. as coagulating bath, and forming, so that the nascent hollow fiber composite membrane is obtained; and
(D) drying for 10 min after putting the nascent hollow fiber composite membrane to a hot air box with a temperature of 70° C., removing residual ammonium sulfate by immersing the dried nascent hollow fiber composite membrane into a second amount of deionized water, putting the dried nascent hollow fiber composite membrane without the residual ammonium sulfate into a multi-roll heat treatment device, heating to 290° C. at a heating rate of 8° C./min, sintering, and performing heat preservation for 2 h, so that the perfluoropolymer hollow fiber composite membrane is obtained.

The perfluoropolymer hollow fiber composite membrane prepared by the above method has a surface separation layer with a thickness of 30 μm. After being continuously tested for 1 h under an operating pressure of 0.02 MPa, the perfluoropolymer hollow fiber composite membrane has a kerosene flux of 1000 L·m⁻²·h⁻¹·bar and a dimethyl sulfoxide flux of 1300 L·m⁻²·h⁻¹·bar.

### Fifth Embodiment

A perfluoropolymer hollow fiber composite membrane preparation method comprises the steps of:
(A) preparing a supporting layer of the perfluoropolymer hollow fiber composite membrane, which comprises weaving basalt fiber filaments into fiber braided tube with an outer diameter of 1800 μm through two-dimensional weaving technology, and performing heat treatment on the fiber braided tube at 350° C. for 5 min to eliminate an internal stress and fix a net structure thereof, thereby obtaining the supporting layer of the perfluoropolymer hollow fiber composite membrane;
(B) preparing a membrane casting solution as a functional layer, which comprises obtaining a mixed solution by mixing a polyperfluoroethylene propylene aqueous dispersion with a concentration of 50 wt. %, a mixture of cellulose with a proportion of 6 wt. % in the mixture and an N-methylmorpholine-N-oxide aqueous solution with a proportion of 94 wt. % in the mixture, and an N-methylmorpholine-N-oxide aqueous solution at 90° C., and defoaming the mixed solution at a constant temperature, so that the membrane casting solution is obtained, wherein a proportion of the polyperfluoroethylene propylene aqueous dispersion in the mixed solution is 25 wt. %, a proportion of the mixture in the mixed solution is 4 wt. %, and a proportion of the N-methylmorpholine-N-oxide aqueous solution in the mixed solution is 71 wt. %;
(C) preparing a nascent hollow fiber composite membrane, which comprises compositing by uniformly coating the membrane casting solution on an outer surface of the supporting layer through an annular spinneret with a temperature of 90° C. using chemical fiber concentric circle composite spinning technology, putting the supporting layer after compositing into a first amount of deionized water with a temperature of 25° C., solidifying and forming, so that the nascent hollow fiber composite membrane is obtained; and
(D) drying for 10 min after putting the nascent hollow fiber composite membrane to a hot air box with a temperature of 75° C., removing residual N-methylmorpholine-N-oxide by immersing the dried nascent hollow fiber composite membrane into a second amount of deionized water, putting the dried nascent hollow fiber composite membrane without the residual N-methylmorpholine-N-oxide into a multi-roll heat treatment device, heating to 310° C. at a heating rate of 15° C./min, sintering, and performing heat preservation for 1 h, so that the perfluoropolymer hollow fiber composite membrane is obtained.

The perfluoropolymer hollow fiber composite membrane prepared by the above method has a surface separation layer with a thickness of 50 After being continuously tested for 1 h under an operating pressure of 0.02 MPa, the perfluoropolymer hollow fiber composite membrane has a kerosene flux of 580 L·m⁻²·h⁻¹·bar and an N,N-dimethylformamide flux of 650 L·m⁻²·h⁻¹ bar.

What is claimed is:

1. A perfluoropolymer hollow fiber composite membrane preparation method comprising the steps of:
(A) preparing a supporting layer of a perfluoropolymer hollow fiber composite membrane;
(B) preparing a membrane casting solution, which comprises obtaining a mixed solution by mixing a perfluoropolymer water dispersion emulsion, a spinning carrier and solvent at a temperature in a range of 60−90° C., and defoaming the mixed solution at a constant temperature, so that the membrane casting solution is obtained, wherein a proportion of the perfluoropolymer water dispersion emulsion in the mixed solution is in a range of 10-40 wt. %, a proportion of the spinning carrier in the mixed solution is in a range of 5-20 wt. %, and a proportion of the solvent in the mixed solution is in a range of 40-85 wt. %;
(C) preparing a nascent hollow fiber composite membrane, which comprises compositing by uniformly coating the membrane casting solution on an outer surface of the supporting layer through an annular spinneret with a temperature in a range of 60−90° C. using chemical fiber concentric circle composite spinning technology, putting the supporting layer after compositing into a coagulant, solidifying and forming, so that the nascent hollow fiber composite membrane is obtained; and
(D) drying for 10-30 min after putting the nascent hollow fiber composite membrane to a hot air box with a temperature in a range of 40−80° C., removing residual coagulant by immersing the dried nascent hollow fiber composite membrane into deionized water, putting the dried nascent hollow fiber composite membrane without the residual coagulant into a heat treatment device, heating to 200-400° C. at a heating rate in a range of 5-20° C./min, sintering, and performing heat preservation for 0.5-5 h, so that the perfluoropolymer hollow fiber composite membrane, comprising the supporting layer and a surface separation layer coated on the supporting layer, is obtained,
wherein the perfluoropolymer is at least one member selected from a group consisting of thermoplastic polyperfluoroethylene propylene (FEP) and thermoplastic tetrafluoroethylene-perfluoropropyl vinyl ether copolymer (PFA).

2. The perfluoropolymer hollow fiber composite membrane preparation method according to claim 1, wherein a content of the perfluoropolymer in the perfluoropolymer water dispersion emulsion is in a range of 30-70 wt. %.

3. The perfluoropolymer hollow fiber composite membrane preparation method according to claim 1, wherein fiber filaments for preparing the supporting layer are acid and alkali resistant glass fiber filaments, basalt fiber filaments, aromatic polyamide fiber filaments or polyimide fiber filaments; the step (A) comprises weaving the fiber filaments into fiber braided tube through two-dimensional weaving technology, and performing heat treatment on the fiber braided tube to eliminate an internal stress and fix a net structure thereof, thereby obtaining the supporting layer of the perfluoropolymer hollow fiber composite membrane.

4. The perfluoropolymer hollow fiber composite membrane preparation method according to claim 1, wherein the spinning carrier is a polyvinyl alcohol aqueous solution with a concentration in a range of 4-10 wt. %, a carboxymethyl cellulose aqueous solution with a concentration in a range of 4-10 wt. %, or a mixture of cellulose with a proportion in a range of 4-10 wt. % in the mixture and an N-methylmorpholine-N-oxide aqueous solution with a proportion in a range of 90-96 wt. % in the mixture, wherein the N-methylmorpholine-N-oxide aqueous solution comprises 87 wt. % of N-methylmorpholine-N-oxide and 13 wt. % of water.

5. The perfluoropolymer hollow fiber composite membrane preparation method according to claim 1, wherein the solvent is deionized water or N-methylmorpholine-N-oxide aqueous solution, wherein N-methylmorpholine-N-oxide aqueous solution comprises 87 wt. % of N-methylmorpholine-N-oxide and 13 wt. % of water.

6. The perfluoropolymer hollow fiber composite membrane preparation method according to claim 1, wherein the coagulant is an inorganic salt saturated aqueous solution which is one or two members selected from a group consisting of a sodium sulfate saturated aqueous solution, a potassium sulfate saturated aqueous solution, and an ammonium sulfate saturated aqueous solution; or the coagulant is anhydrous ethanol, anhydrous methanol or deionized water.

7. The perfluoropolymer hollow fiber composite membrane preparation method according to claim 1, wherein the surface separation layer has a thickness in a range of 10-100 μm, and an outer diameter of the supporting layer is in a range of 500-2000 μm.

8. The perfluoropolymer hollow fiber composite membrane preparation method according to claim 1, wherein the heat treatment device is an intermittent hot box treatment device, a continuous hot roll treatment device or a continuous hot plate treatment device.

9. A perfluoropolymer hollow fiber composite membrane prepared by the perfluoropolymer hollow fiber composite membrane preparation method according to claim 1, wherein the membrane has an oil flux in a range of 200-1300 L·m⁻²·h⁻¹·bar and an organic solvent flux in a range of 300-1500 L·m⁻²·h⁻¹·bar, the oil is kerosene, diesel, gasoline, benzene or halogenated alkanes; the solvent is N,N-dimethylformamide, N,N-dimethylacetamide, dimethyl sulfoxide or N-methylpyrrolidone.
